(19) United States
(12) Patent Application Publication
(10) Pub. No.: US 2010/0079363 A1
(43) Pub. Date: Apr. 1, 2010

(54) Liquid Crystal Panel, Liquid Crystal Display Apparatus and Driving Apparatus of Liquid Crystal Panel

(75) Inventors: Te-Chen Chung, Kunshan City (CN); Wenjun Dai, Kunshan City (CN); Chia-Te Liao, Kunshan City (CN); Tean-Sen Jen, Kunshan City (CN)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: INFOVISION OPTOELECTRONICS (KUSHAN) CO., LTD., Kushan (CN)

(21) Appl. No.: 12/433,482

(22) Filed: Apr. 30, 2009

(30) Foreign Application Priority Data
Sep. 28, 2008 (CN) 200810167762.5

(51) Int. Cl. G09G 3/36

(52) U.S. Cl. 345/92

(57) ABSTRACT

A liquid crystal display apparatus includes M data lines arranged in columns, N scanning lines arranged in rows, and pixels determined by intersection of the M data lines and the N scanning lines. M and N are integers greater than 1. The N scanning lines are divided into 2K scanning line groups; K is an integer greater than or equal to 1; and the scanning lines in each scanning line group are connected with pixels having the same polarity. The liquid crystal display apparatus further includes: 2K driving components, each of which corresponding to one scanning line group and being configured to provide a plurality of levels of outputs, each level of outputs being connected with one scanning line in the scanning line group to activate the scanning line. Thus, power consumption can be saved effectively.

### FIELD OF THE INVENTION

The present invention relates to the field of liquid crystal display, and more particularly to a liquid crystal panel, a liquid crystal display apparatus and a driving apparatus of a liquid crystal panel.

### BACKGROUND OF THE INVENTION

As well known, liquid crystals have different optical properties at different voltage levels, which can be applied for the liquid crystal display. Each pixel in a liquid crystal panel consists of a Thin Film Transistor (TFT), a pixel electrode, a common electrode and a liquid crystal layer enclosed between the two electrodes. By applying a predetermined voltage to an upper electrode and a lower electrode of the liquid crystal layer, i.e. the common electrode and the pixel electrode, the alignment of liquid crystal molecules in the liquid crystal layer is changed, so that the optical transmissivity of each pixel is changed. In this way, the display of images is realized. It should be noted that, when the voltage of the pixel electrode is higher than the voltage of the common electrode, the pixel presents a positive polarity, represented as “+”; while when the voltage of the pixel electrode is lower than the voltage of the common electrode, the pixel presents a negative polarity, represented as “−”. However, if the alignment of the liquid crystal molecules is kept unchanged, physical characteristics of the liquid crystal molecules may be destroyed permanently, and thus the liquid crystals are deteriorated. In order to prevent the deterioration of the liquid crystals and maintain the display quality of images, the direction of the electric field applied to each pixel is inverted at regular intervals. In other words, the polarity of each pixel is inverted between the positive and the negative at regular intervals to ensure that the alignment of the liquid crystal molecules changes continuously. The inversion of the polarity of each pixel between the positive and the negative is referred to as alternating driving. Currently, there are four alternating driving manners for the liquid crystal panel: a frame inversion driving manner, a row inversion driving manner, a column inversion driving manner and a dot inversion driving manner. The dot inversion driving manner can eliminate crosstalk and flicker better, and can achieve higher display quality of images. Therefore, current liquid crystal panels generally adopt the dot inversion driving manner. The dot inversion driving manner includes: a single-dot inversion driving manner, also called 1V1H dot inversion driving manner, and a double-dot inversion driving manner, also called 2V1H dot inversion driving manner. In the liquid crystal panel adopting the single-dot inversion driving manner, the polarity of each pixel is opposite to polarities of adjacent pixels, as shown in FIG. 1. In the liquid crystal panel adopting the double-dot inversion driving manner, the adjacent two pixels in one column are regarded as one group, polarities of the two pixels in each group are the same, and the polarities of the two pixels in each group are opposite to those in adjacent groups, as shown in FIG. 2.

FIG. 3 is a circuit diagram illustrating part of pixels in a liquid crystal panel adopting the single-dot inversion driving manner. As shown in FIG. 3, the liquid crystal panel includes N rows of scanning lines parallel with one another, M columns of data lines parallel with one another, and a plurality of pixels. The M columns of data lines intersect with the N rows of scanning lines insulatively and vertically. Each scanning line connects all the pixels in one row, and each data line connects all the pixels in one column. The smallest area surrounded by the scanning lines and the data lines is defined as a pixel area. Each pixel in the liquid crystal panel includes a TFT 300. The gate electrode of the TFT 300 is connected to one scanning line to receive a scanning signal provided by the scanning line; the source electrode of the TFT 300 is connected to one data line to receive a data voltage signal provided by the data line; the drain electrode of the TFT 300 is connected to the pixel electrode. A liquid crystal capacitor C_{LC} 301 is formed between the pixel electrode and the common electrode of an opposite substrate which is also called an opposite electrode, and a storage capacitor Cₛₜ 302 is formed between the pixel electrode and the common electrode of an array substrate which is also called a storage electrode. As can be seen, the TFT 300 functions as a switch element of a pixel to drive the pixel electrode.

With respect to the liquid crystal panel adopting the single-dot inversion driving manner in FIG. 3, the data voltage inputted to a certain data line is an AC voltage, represented as “Vdata”; the common voltage provided to the common electrode of a pixel is a DC voltage, represented as “Vcom”. When the data voltage is higher than the common voltage, the data voltage is positive, represented as “Vdata+”, and the pixel has a positive polarity. When the data voltage is lower than the common voltage, the data voltage is negative, represented as “Vdata−”, and the pixel has a negative polarity. Herein, a positive data voltage means that the voltage difference between the data voltage and the common voltage is positive; and a negative data voltage means that the voltage difference between the data voltage and the common voltage is negative. The above explanation is also applicable to all the embodiments of the present invention. When one scanning line is activated, all the TFTs connected to the activated scanning line are turned on. Thus, if the data voltage inputted to a certain data line is positive, the data voltage on the data line should be changed to be negative while the next scanning line is activated, in order to realize the single-dot inversion driving. Similarly, the data voltage on a data line adjacent to the data line should be changed to be positive from negative, so as to ensure that each pixel has a polarity opposite to polarities of adjacent pixels. FIG. 4 is a waveform graph illustrating a data voltage and a common voltage which are inputted to the liquid crystal panel shown in FIG. 3. As shown in FIG. 4, because all the scanning lines needs to be scanned row by row in one frame of time, the data voltage on each data line in the liquid crystal panel needs to be changed frequently in one frame of time. Because the data voltage is changed frequently, power consumption of the liquid crystal panel is increased.

In order to save the power consumption, some improved liquid crystal panels are provided in the prior art. FIGS. 5 and 6 are circuit diagrams illustrating part of pixels of two types of improved liquid crystal panels. As shown in FIG. 5, the scanning line n connects the pixels in odd columns and in two adjacent rows, while the scanning line n−1 (not shown) and the scanning line n+1 which are adjacent to the scanning line n connect the pixels in even columns and in two adjacent rows. The data line m connects the pixels with negative polarities in two adjacent columns, while the data line m−1 (not shown) and the data line m+1 which are adjacent to the data line m connect the pixels with positive polarities in two adjacent columns. As shown in FIG. 6, a scanning line connects all the pixels in one row, the data line m connects the pixels with negative polarities in two adjacent columns, while the data line m−1 (not shown) and the data line m+1 which are adjacent to the data line m connect the pixels with positive polarities in two adjacent columns. The liquid crystal panels with such pixel arrangement as shown in FIGS. 5 and 6 are called Z-type liquid crystal panels. In the Z-type liquid crystal panel, the single-dot inversion driving may be realized without changing the data voltages inputted to the data lines in one frame of time, thereby saving power consumption effectively. However, for the Z-type liquid crystal panel, the pixel arrangement has to be changed based on the liquid crystal panel shown in FIG. 3.

Therefore, it is an urgent need for a liquid crystal display apparatus, by which not only power consumption can be saved effectively, but also the pixel arrangement of the liquid crystal panel does not need to be changed.

### SUMMARY OF THE INVENTION

Embodiments of the present invention provide a liquid crystal panel, a liquid crystal display apparatus and a driving apparatus of a liquid crystal panel, and thereby power consumption can be saved without changing the pixel arrangement in the liquid crystal panel.

An embodiment of the present invention provides a liquid crystal panel, including: M data lines arranged in columns, N scanning lines arranged in rows, pixels determined by intersection of the M data lines and the N scanning lines, M and N being integers greater than 1; and

N gate driver units, each of which is electrically connected with one scanning line to activate the scanning line; wherein

the N gate driver units are divided into 2K gate driver unit groups and the N scanning lines are divided into 2K scanning line groups, K being an integer greater than or equal to 1 and each scanning line group corresponding to one gate driver unit group; and

the 2K gate driver unit groups are interlaced at two sides of the liquid crystal panel, the gate driver units in each gate driver unit group of the 2K gate driver unit groups are cascaded with one another and the gate driver units in different gate driver unit groups of the 2K gate driver unit groups are not connected with one another.

An embodiment of the present invention further provides a liquid crystal display apparatus, including: M data lines arranged in columns, N scanning lines arranged in rows, pixels determined by intersection of the M data lines and the N scanning lines, M and N being integers greater than 1; and

2K driving components, wherein

the N scanning lines are divided into 2K scanning line groups, K being an integer greater than or equal to 1, the scanning lines in each scanning line group being connected with pixels having the same polarity; and

each of the 2K driving components corresponds to one scanning line group and is configured to provide a plurality of levels of outputs, each level of outputs being connected with one scanning line in the scanning line group to activate the scanning line.

An embodiment of the present invention further provides a driving apparatus of a liquid crystal panel, applied to M data lines arranged in columns, N scanning lines arranged in rows, and pixels determined by intersection of the M data lines and the N scanning lines, M and N being integers greater than 1; wherein

the N scanning lines are divided into 2K scanning line groups, K being an integer greater than or equal to 1, and the scanning lines in each scanning line group are connected with pixels having the same polarity;

the driving apparatus comprises:

2K driving components, each of which corresponds to one scanning line group and is configured to provide a plurality of levels of outputs, each level of output being connected with one scanning line in the scanning line group to activate the scanning line.

As can be seen from the above solutions, in the embodiments of the present invention, by dividing the scanning beams into 2K groups, scanning different groups in different periods of time and scanning the scanning beams in one group one by one, the polarity of the data voltage applied to any data line does not need to be changed frequently but only be changed after one group of scanning lines are all scanned. Therefore, compared with the prior art, the liquid crystal panel, the liquid crystal display apparatus and the driving apparatus of a liquid crystal panel according to the embodiments of the present invention can save power consumption much more.

### BRIEF DESCRIPTION OF THE DRAWINGS

To describe the embodiments of the present invention or the solutions of the prior art more clearly, accompanying drawings of the embodiments of the present invention or those of the prior art will be briefly described hereinafter. Obviously, the following drawings are only some embodiments of the present invention, and those skilled in the art can obtain other drawings according to the following drawings without any inventive efforts.

FIG. 1 is a schematic diagram illustrating a polarity of each pixel in a liquid crystal panel adopting a single-dot inversion driving manner.

FIG. 2 is a schematic diagram illustrating a polarity of each pixel in a liquid crystal panel adopting a double-dot inversion driving manner.

FIG. 3 is a circuit diagram illustrating part of pixels in a liquid crystal panel adopting the single-dot inversion driving manner.

FIG. 4 is a waveform graph illustrating a data voltage and a common voltage which are inputted to the liquid crystal panel shown in FIG. 3.

FIGS. 5 and 6 are circuit diagrams illustrating part of pixels in two types of improved liquid crystal panels on FIG. 3.

FIG. 7 is a schematic diagram illustrating a liquid crystal display apparatus according to an embodiment of the present invention.

FIG. 8(a) is a schematic diagram illustrating a part of a driving apparatus of a liquid crystal panel adopting the single-dot inversion driving manner according to an embodiment of the present invention.

FIG. 8(b) is a timing diagram of scanning lines when the driving apparatus shown in FIG. 8(a) are adopted.

FIG. 9 is a schematic effect diagram of a liquid crystal display apparatus adopting the single-dot inversion driving manner according to an embodiment of the present invention.

FIGS. 10(a) and (b) are waveform graphs illustrating a data voltage and a common voltage which are inputted to a liquid crystal panel according to an embodiment of the present invention.

FIG. 11 is a schematic diagram illustrating a part of a driving apparatus of a liquid crystal panel adopting the double-dot inversion driving manner according to an embodiment of the present invention.

FIG. 12 is a schematic effect diagram of a liquid crystal display apparatus adopting the double-dot inversion driving manner according to an embodiment of the present invention.

FIG. 13 is a schematic diagram illustrating a part of repair structure of a driving apparatus of a liquid crystal panel adopting the double-dot inversion driving manner according to an embodiment of the present invention.

FIGS. 14(a) and (b) are schematic diagrams illustrating details of repair structures of part of gate driver units shown in FIG. 13.

FIG. 15 is a schematic effect diagram of a liquid crystal display apparatus adopting the single-dot inversion driving manner according to another embodiment of the present invention.

FIG. 16 is a schematic effect diagram of a liquid crystal display apparatus adopting the double-dot inversion driving manner according to another embodiment of the present invention.

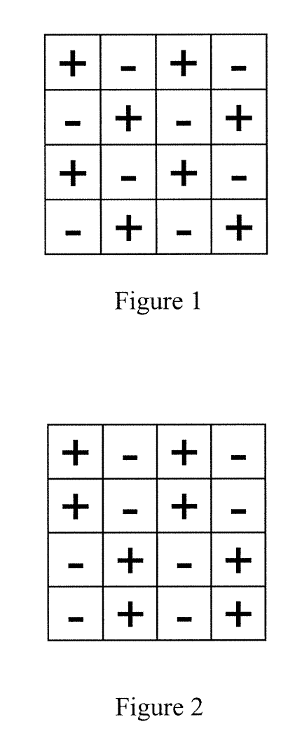

### DETAILED DESCRIPTION OF THE INVENTION

The embodiments of the present invention are described in detail hereinafter with reference to the accompanying drawings of the embodiments of the present invention. Obviously, the embodiments are only a part of embodiments but not all embodiments. Other embodiments made by those skilled in the art according to the embodiments of the present invention without any inventive efforts are also in the protection scope of the present invention.

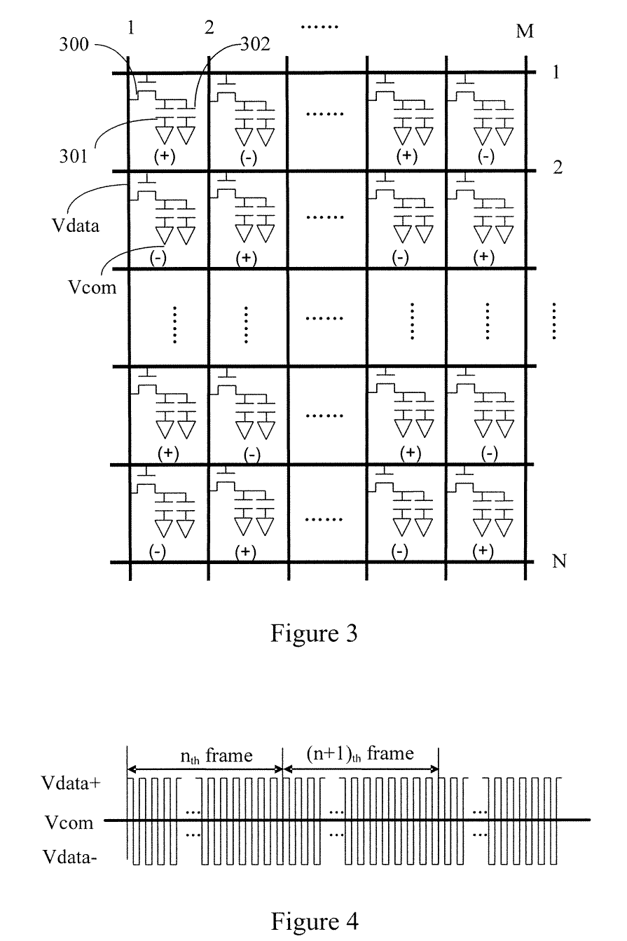

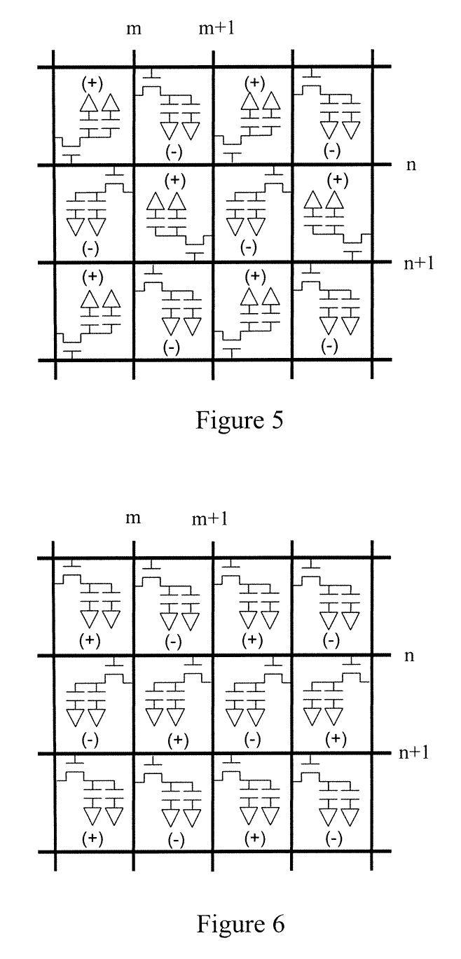

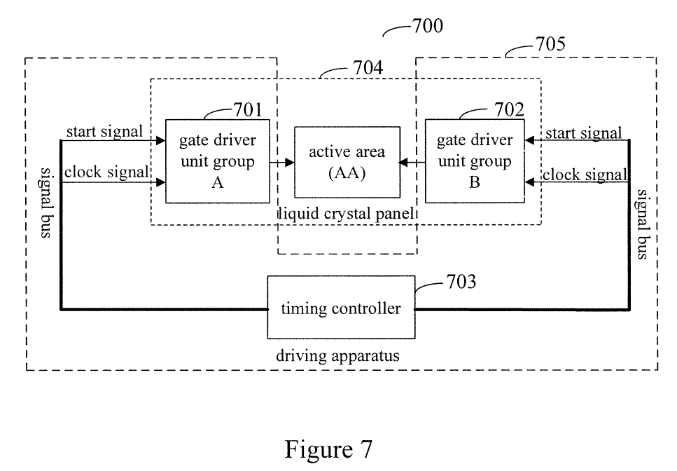

FIG. 7 is a schematic diagram illustrating a liquid crystal display apparatus according to an embodiment of the present invention. As shown in FIG. 7, the liquid crystal display apparatus 700 includes the liquid crystal panel 704. The liquid crystal panel 704 includes N rows of scanning lines parallel with one another, M columns of data lines parallel with one another, a plurality of pixels determined by the intersection of the scanning lines and the data lines, and a plurality of gate driver units placed at the left and right sides of an Active Area (AA). The liquid crystal panel 704 adopts the pixel arrangement of the liquid crystal panel shown in FIG. 3, i.e. each scanning line is electrically connected with all the pixels in one row and each data line is electrically connected with all the pixels in one column. Each gate driver unit is electrically connected with one scanning line to activate the scanning line. The gate driver units placed at the left side of the liquid crystal panel form the gate driver unit group A, also called the driving component A; the gate driver units placed at the right side of the liquid crystal panel form the gate driver unit group B, also called the driving component B. Certainly, in the liquid crystal display apparatus 700 provided by the embodiments of the present invention, the plurality of gate driver units are not limited to be embedded in the liquid crystal panel; instead, a plurality of gate driver units may also be placed in the driving apparatus 705 outside the liquid crystal panel. The liquid crystal display apparatus further includes the Timing Controller (Tcon) 703. The gate driver units placed at the left and right sides of the liquid crystal panel are connected to the Tcon 703 through a signal bus, so as to receive clock signals and start signals from the Tcon 703. When the pixels in the liquid crystal panel needs to be scanned, the gate driver units in the gate driver unit group A activate the scanning lines connected with the gate driver units in the gate driver unit group A one by one; after the scanning lines connected with the gate driver units in the gate driver unit group A are scanned, the timing controller controls the gate driver units in the gate driver unit group B to activate the scanning lines connected with the gate driver units in the gate driver unit group B one by one; and thereby, all the scanning lines in the liquid crystal panel 704 are scanned successfully. As shown in FIG. 7, the gate driver unit group A 701 and the gate driver unit group B 702 form the driving apparatus 705 of the liquid crystal panel 704, and the driving apparatus 705 may further include the Tcon 703.

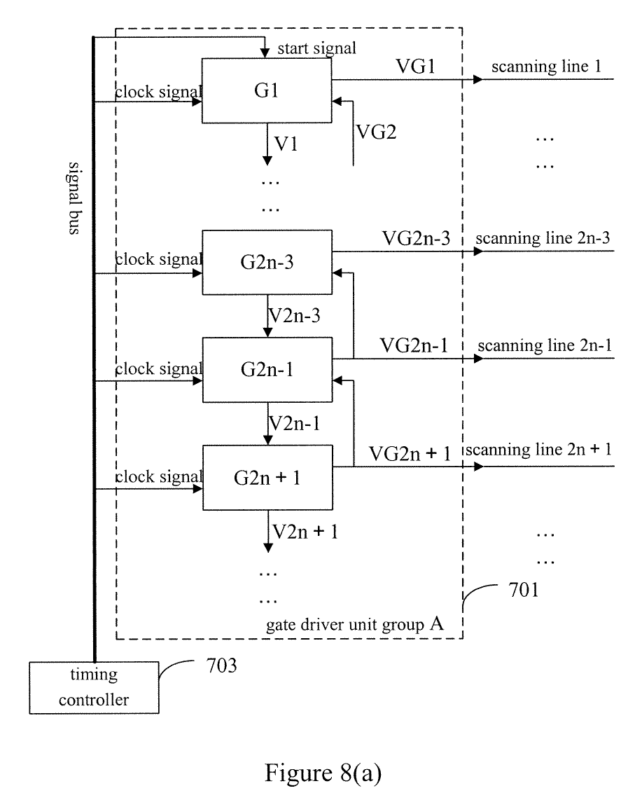

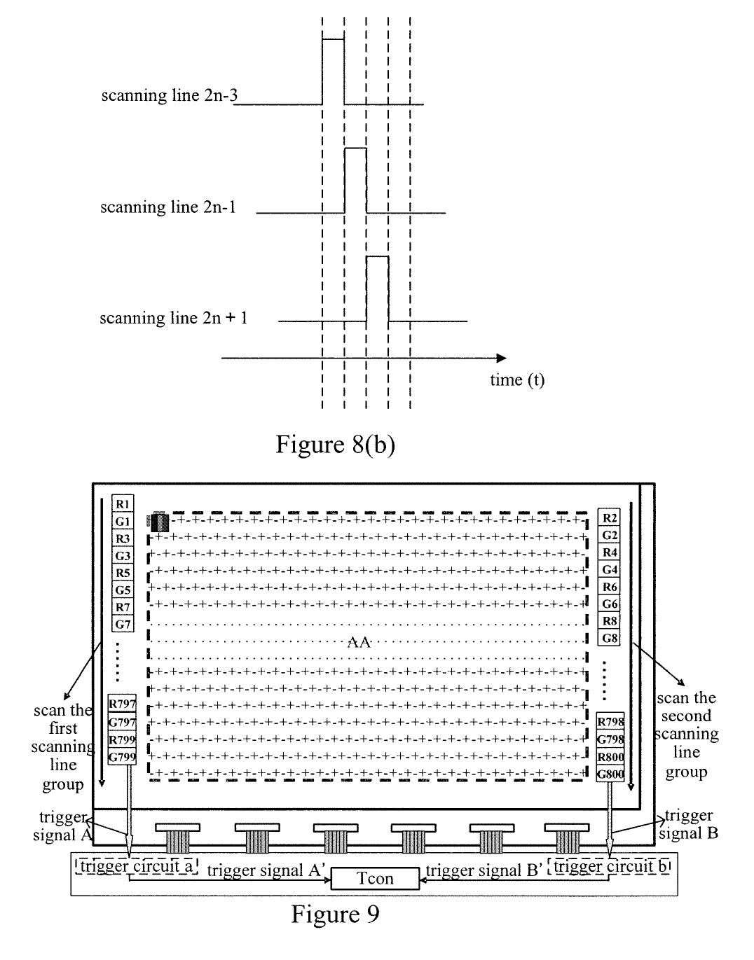

FIG. 8(a) is a schematic diagram illustrating a part of a driving apparatus of a liquid crystal panel adopting the single-dot inversion driving manner according to an embodiment of the present invention. The driving apparatus in this embodiment is applied to the liquid crystal panel adopting the single-dot inversion driving manner.

In this embodiment, N scanning lines are divided into two scanning line groups. One scanning line group includes scanning lines in odd rows among the N scanning lines, and the other scanning line group includes scanning lines in even rows among the N scanning lines. The gate driver units in the gate driver unit group A are placed at the left side of the liquid crystal panel and are connected with the scanning lines in odd rows, respectively represented as G1, G3, . . . , G2n−1, . . . , GN−1, wherein N is the number of the scanning lines. The gate driver units in the gate driver unit group B are placed at the right side of the liquid crystal panel and are connected with the scanning lines in even rows, respectively represented as G2, G4, . . . , G2n, . . . , GN. All the gate driver units at the left and the right sides of the liquid crystal panel are connected to a signal bus, and the signal bus is connected to the timing controller through an external Printed Circuit Board (PCB, not shown in FIG. 7). The gate driver units in one gate driver unit group and at the same side are electrically connected with one another, while the gate driver units at different sides are not electrically connected with one another. Because the connection relation and working principle of the gate driver units at the right side of the liquid crystal panel are the same as those of the gate driver units at the left side of the liquid crystal panel, FIG. 8(a) only illustrates a schematic diagram of the gate driver units at the left side of the liquid crystal panel, without showing the gate driver units at the right side of the liquid crystal panel. Certainly, as an alternative, the gate driver units connected with the scanning lines in odd rows may be placed at the right side of the liquid crystal panel, and the gate driver units connected with the scanning lines in even rows may be placed at the left side of the liquid crystal panel. Therefore, the embodiments of the present invention are just for describing the technical solution clearly but are not for use in limiting the present invention.

As shown in FIG. 8(a), all the gate driver units in the gate driver unit group A are cascaded according to the sequence of the scanning lines, and each gate driver unit equals to a shift register. Clock signals of all the gate driver units are provided by the timing controller, and a shift trigger signal outputted by a gate driver unit is taken as an input of the next gate driver unit. When the pixels of the liquid crystal panel needs to be scanned, the timing controller generates a start signal, and sends the start signal to the first gate driver unit G1 in the gate driver unit group A at the left side of the liquid crystal panel, wherein the start signal is taken as an input of the first gate driver unit G1. The timing controller further outputs clock signals to all the gate driver units at the left side. When a clock signal arrives, the gate driver unit G1 generates the scanning pulse signal VG1 to activate the scanning line 1, and generates the shift trigger signal V1 as an input of the next gate driver unit G3. The rest may be deduced by analogy, each gate driver unit, e.g. G2n−3, sends the generated shift trigger signal V2n−3 to the gate driver unit G2n−1 to trigger the gate driver unit G2n−1, so that the gate driver unit G2n−1 gets ready to generate the scanning pulse signal VG2n−1 when its clock signal arrives. After obtaining the shift trigger signal V2n−3 from the gate driver unit G2n−3, the gate driver unit G2n−1 generates the shift trigger signal V2n−1 when the clock signal provided by the timing controller arrives. And simultaneously, the gate driver unit G2n−1 generates the scanning pulse signal VG2n−1 to activate the scanning line 2n−1 connected with the gate driver unit G2n−1, and takes the scanning pulse signal VG2n−1 as an input signal of the former gate driver unit G2n−3 to notify the gate driver unit G2n−3 to turn off the scanning line 2n−3 connected with the gate driver unit G2n−3. And then the gate driver unit G2n−1 sends the shift trigger signal V2n−1 to the gate driver unit G2n+1. Upon receiving the shift trigger signal V2n−1, the gate driver unit G2n+1 generates the shift trigger signal V2n+1 and the scanning pulse signal VG2n+1 to activate the scanning line 2n+1 connected with the gate driver unit G2n+1 when a clock signal arrives. Timing diagram of the scanning lines connected respectively with the gate driver units are shown in FIG. 8(b), and to be brief, only the timing diagram of the scanning lines 2n−3, 2n−1 and 2n+1 are shown.

According to the driving apparatus shown in FIG. 8(a), FIG. 9 is a schematic effect diagram of a liquid crystal display apparatus adopting the single-dot inversion driving manner according to an embodiment of the present invention. As shown in FIG. 9, the liquid crystal panel adopts the single-dot inversion driving manner and it is supposed that the number of scanning lines is 800. The gate driver units G1, G3, . . . , G799 at the left side of the liquid crystal panel are connected with the scanning lines in odd rows, called the first scanning line group; and the gate driver units G2, G4, . . . , G800 at the right side of the liquid crystal panel are connected with the scanning lines in even rows, called the second scanning line group. After all the scanning lines in the first scanning line group connected with the gate driver units at the left side of the liquid crystal panel are scanned one by one from top to bottom, the final gate driver unit G799 outputs the shift trigger signal V799 to the trigger circuit a connected with the final gate driver unit G799 through a signal bus, and the shift trigger signal V799 is taken as the trigger signal A of the trigger circuit a. Upon receiving the trigger signal A, the trigger circuit a generates the trigger signal A′ and sends the trigger signal A′ to the timing controller. Upon receiving the trigger signal A′ sent by the trigger circuit a, the timing controller generates the start signal A as an input of the first gate driver unit G2 at the right side. When a clock signal provided by the timing controller arrives, the gate driver unit G2 generates the scanning pulse signal VG2 to activate the scanning line 2 connected with the gate driver unit G2, generates the shift trigger signal V2, and sends to the next gate driver unit G4 the shift trigger signal V2 as an input of the next gate driver unit G4, thereby starting to scan the scanning lines in the second scanning line group one by one from top to bottom. When a clock signal provided by the timing controller arrives, the gate driver unit G4 generates the scanning pulse signal VG4 and sends the scanning pulse signal VG4 to the former gate driver unit G2 to notify the gate driver unit G2 to turn off the scanning line 2. After the scanning lines in the second scanning line group are scanned, the final gate driver unit G800 outputs the shift trigger signal V800 to the trigger circuit b connected with the gate driver unit G800 through the signal bus, and the shift trigger signal V800 is taken as the trigger signal B of the trigger circuit b. The trigger circuit b generates the trigger signal B′ and sends the trigger signal B′ to the timing controller. Upon receiving the trigger signal B′ sent by the trigger circuit b, the timing controller generates the start signal B, thereby starting to scan the scanning lines in the first scanning line group again when the next frame starts.

Certainly, after the scanning lines in the first scanning line group connected with the gate driver units at the left side of the liquid crystal panel are scanned, the scanning lines in the second scanning line group may be directly activated by the timing controller instead of the trigger circuit a. For example, the final gate driver unit G799 at the left side does not send the outputted shift trigger signal V799 to the trigger circuit a; instead, the timing controller calculates, according to a preset clock period, the time needed for scanning all the scanning lines in the first scanning line group, i.e. ½ frame of time. When detecting that the ½ frame of time is past, the timing controller sends the start signal to the first gate driver unit G2 at the right side, wherein the start signal is taken as an input signal of the first gate driver unit G2 at the right side; and thereby, the scanning lines in the second scanning line group connected with the gate driver units at the right side are scanned one by one during the next ½ frame of time.

The driving apparatus shown in FIG. 8(a) may also be applied to all the liquid crystal panels adopting the single-dot inversion driving manner as an external driving apparatus. However, according to the embodiment of the present invention illustrated in FIG. 9, all the gate driver units are embedded in the liquid crystal panel and are interlaced at the left and right sides of the liquid crystal panel, and the trigger circuits and the timing controller are external circuits of the liquid crystal panel, and thereby optimizing the layout of the liquid crystal panel and saving production costs. The liquid crystal panel including the gate driver units provided by the embodiments of the present invention may be applied widely, and can save power consumption only if the liquid crystal panel is externally connected the timing controller when applied.

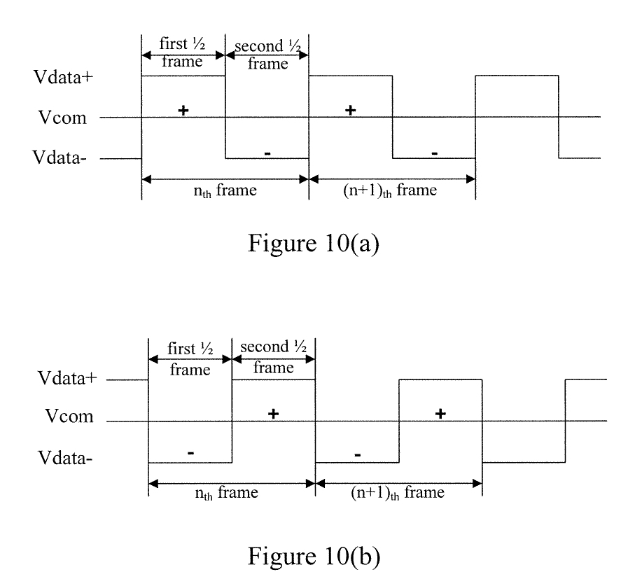

As can be seen from the above embodiments, when the liquid crystal panel adopts the single-dot inversion driving manner, by placing one group of gate driver units at the two sides of the liquid crystal panel respectively, the liquid crystal panel may scan the scanning lines in odd rows one by one during the former ½ frame of time in one frame of time and may scan the scanning lines in even rows one by one during the latter ½ frame of time in one frame of time, and thus all the scanning lines of the liquid crystal panel may be scanned successfully in one frame of time. In the former ½ frame of time, when the scanning pulse signal generated by the gate driver unit Gn−1 arrives at the scanning line n−1, the scanning line n−1 is activated, the TFTs of all the pixels connected with the scanning line n−1 are turned on, and data voltages are inputted through the data lines to all the pixels connected with the scanning line n−1. In order to ensure that a pixel has a polarity opposite to those of adjacent pixels, if the data voltage on the data line m is positive, the data voltages on the data line m−1 and the data line m+1 which are adjacent to the data line m are negative. Because each pixel of the conventional liquid crystal panel adopting the single-dot inversion driving manner has a polarity opposite to those of adjacent pixels, when the scanning line n+1 is activated, the data voltage applied to the data line m is still positive, and the data voltages on the data line m−1 and the data line m+1 which are adjacent to the data line m are still negative. After the scanning lines in odd rows are scanned, the scanning lines in even rows connected with the gate driver units at the right side of the liquid crystal panel are activated one by one; then, the data voltage on the data line m is changed to be negative, and the data voltages on the data line m−1 and the data line m+1 which are adjacent to the data line m are changed to be positive. In other words, in the former ½ frame of time, while the scanning lines in odd rows connected with the gate driver units at the left side of the liquid crystal panel are scanned one by one, the data voltage on a certain data line connected with the pixels in one column does not need to be changed between the positive and the negative, and it is only necessary to guarantee that the data voltage on a data line has a polarity opposite to those of adjacent data lines. In the latter ½ frame of time, while the scanning lines in even rows connected with the gate driver units at the right side of the liquid crystal panel are scanned one by one, the data voltages on all the data lines should be changed to the data voltages with the polarity opposite to those in the former ½ frame of time, and thus it can be guaranteed that each pixel has a polarity opposite to those of adjacent pixels. Consequently, the polarity of the data voltage applied to each data line is changed only once in one frame of time, and thereby effectively saving the power consumption. FIGS. 10(a) and (b) are waveform graphs illustrating a data voltage and a common voltage which are inputted to a liquid crystal panel according to an embodiment of the present invention.

Although the embodiments of the present invention take an example that the scanning lines in odd rows are scanned in the former ½ frame of time in one frame of time and the scanning lines in even rows are scanned in the latter ½ frame of time in one frame of time, it can be understood by those skilled in the art that the scanning lines in even rows may be scanned in the former ½ frame of time while the scanning lines in odd rows may be scanned in the latter ½ frame of time. It should be noted that the scanning sequence in the embodiments is not for use in limiting the present invention and will not affect the display quality of images.

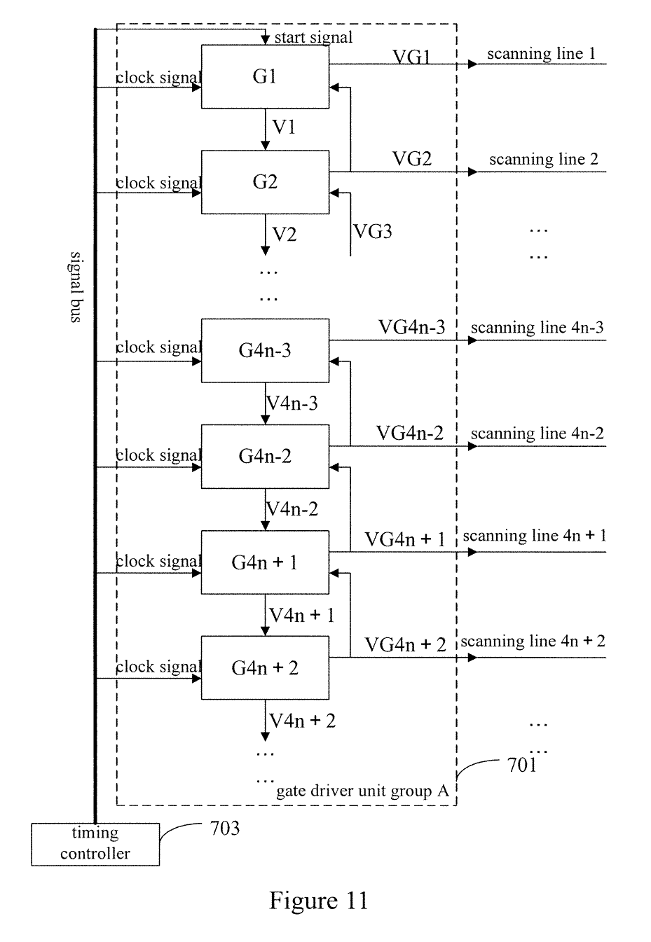

The liquid crystal display apparatus according to the above embodiments uses the liquid crystal panel adopting the single-dot inversion driving manner, and the driving apparatus shown in FIG. 8(a) is applied to the liquid crystal panel adopting the single-dot inversion driving manner. However, the liquid crystal panel may adopt the double-dot inversion driving manner alternatively. Therefore, an embodiment of the present invention further provides a driving apparatus of the liquid crystal panel adopting the double-dot inversion driving manner. FIG. 11 is a schematic diagram illustrating a part of a driving apparatus of a liquid crystal panel adopting the double-dot inversion driving manner according to an embodiment of the present invention.

In this embodiment, N scanning lines are divided into two scanning line groups and N/2 scanning line subgroups. Each scanning line subgroup includes two adjacent scanning lines. One scanning line group includes scanning lines in odd subgroups among the N/2 scanning line subgroups, and the other scanning line group includes scanning lines in even subgroups among the N/2 scanning line subgroups. Gate driver units in the gate driver unit group A are placed at the left side of the liquid crystal panel, respectively represented as G1, G2, G5, G6, . . . , G4n−3, G4n−2, . . . , GN−3 and GN−2, and are respectively connected with scanning lines 1, 2, 5, 6, . . . , 4n−3, 4n−2, . . . , N−3 and N−2. N is the number of the scanning lines. Gate driver units in the gate driver unit group B are placed at the right side of the liquid crystal panel, respectively represented as G3, G4, G7, G8, . . . , G4n−1, G4n, . . . , GN−1 and GN, and are respectively connected with scanning lines 3, 4, 7, 8, . . . , 4n−1, 4n, . . . , GN−1 and GN. The gate driver units at the left and right sides of the liquid crystal panel are all connected with a signal bus, and the signal bus is connected to an external timing controller through an external Printed Circuit Board (PCB, not shown in FIG. 11). The gate driver units in one scanning line group and at the same side are electrically connected with one another, while the gate driver units at different sides are not electrically connected with one another. Similar to FIG. 8(a), FIG. 11 only illustrates the gate driver units at the left side of the liquid crystal panel, while the gate driver units at the right side are not shown.

As shown in FIG. 11, all the gate driver units in the gate driver unit group A are cascaded according to the sequence of the scanning lines and receive clock signals provided by the timing controller. A shift trigger signal outputted by a gate driver unit is taken as an input of the next gate driver unit. When the pixels of the liquid crystal panel needs to be scanned, the timing controller generates a start signal, and sends the start signal to the first gate driver unit G1 in the gate driver unit group A at the left side of the liquid crystal panel, wherein the start signal is taken as an input of the gate driver unit G1. The timing controller further outputs clock signals to all the gate driver units at the left side. When a clock signal arrives, the gate driver unit G1 generates the scanning pulse signal VG1 to activate the scanning line 1, and generates the shift trigger signal V1 as an input of the next gate driver unit G2. The rest may be deduced by analogy, each gate driver unit, e.g. G4n−3, sends the generated shift trigger signal V4n−3 to the gate driver unit G4n−2 to trigger the gate driver unit G4n−2, so that the gate driver unit G4n−2 gets ready to generate the scanning pulse signal VG4n−2 when its clock signal arrives. Upon receiving the shift trigger signal V4n−3 from the gate driver unit G4n−3, the gate driver unit G4n−2 generates the shift trigger signal V4n−2 when the clock signal provided by the timing controller arrives. And simultaneously, the gate driver unit G4n−2 generates the scanning pulse signal VG4n−2 to activate the scanning line 4n−2 connected with the gate driver unit G4n−2, takes the scanning pulse signal VG4n−2 as an input signal of the former gate driver unit G4n−3 to notify the gate driver unit G4n−3 to turn off the scanning line 4n−3 connected with the gate driver unit G4n−3, and then sends the shift trigger signal V4n−2 to the gate driver unit G4n+1. Upon receiving the shift trigger signal V4n−2, the gate driver unit G4n+1 generates the shift trigger signal V4n+1 and the scanning pulse signal VG4n+1 to activate the scanning line 4n+1 connected with the gate driver unit G4n+1.

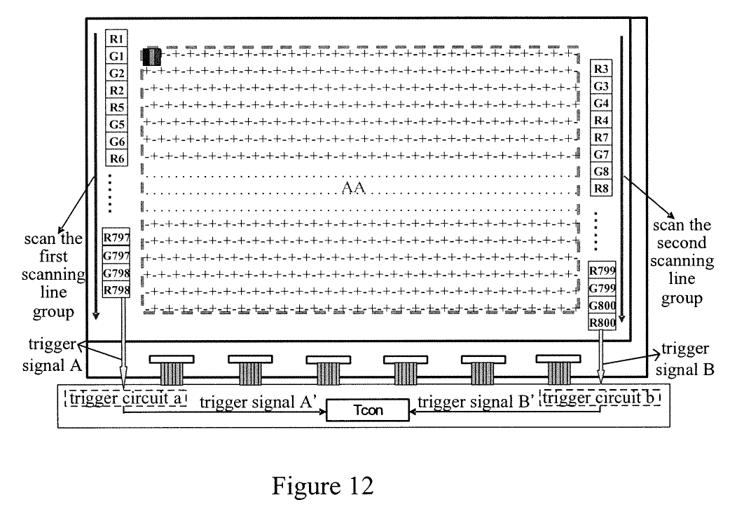

According to the driving apparatus shown in FIG. 11, FIG. 12 illustrates a schematic effect diagram of the liquid crystal display apparatus adopting the double-dot inversion driving manner according to an embodiment of the present invention. As shown in FIG. 12, the liquid crystal panel adopts the double-dot inversion driving manner, and it is supposed that the number of scanning lines is 800. The gate driver units G1, G2, G5, G6, . . . , G797 and G798 at the left side of the liquid crystal panel are respectively connected with the scanning lines 1, 2, 5, 6, . . . , 797 and 798, called the first scanning line group. The gate driver units G2, G4, G7, G8, . . . , G799 and G800 at the right side of the liquid crystal panel are connected respectively with the scanning lines 2, 4, 7, 8, . . . , 799 and 800, called the second scanning line group.

When the scanning lines connected with the gate driver units at the left side needs to be scanned, the scanning lines 1, 2, 5, 6, . . . , 797 and 798 are scanned in turn. After the scanning lines connected with the gate driver units at the left side are all scanned, the scanning lines 2, 4, 7, 8, . . . , 799 and 800 connected with the gate driver units at the right side start to be scanned. Thus, the data voltage on a certain data line connected with pixels in one column does not need to be change between the positive and the negative in the former ½ frame of time in one frame of time, and it is only necessary to guarantee that the data voltage on the data line has a polarity opposite to those of adjacent data lines. In the latter ½ frame of time in one frame of time, the data voltages on all the data lines should be changed to the data voltages with the polarity opposite to those in the former ½ frame of time. In this way, the requirements of the polarities of the pixels in the liquid crystal panel adopting the double-dot inversion driving manner can be met. As can be seen, the polarity of the data voltage applied to each data line is changed only once in one frame of time, and thereby effectively saving the power consumption.

In this embodiment, after the scanning lines in the first scanning line group are scanned, the trigger circuit a and the timing controller may control the activation of the scanning lines in the second scanning line group together, or only the timing controller controls the activation of the scanning lines in the second scanning line group without the trigger circuit a.

The driving apparatus shown in FIG. 11 may be applied as an external driving apparatus to all the liquid crystal panels adopting the double-dot inversion driving manner. However, according to the embodiment of the present invention illustrated in FIG. 12, all the gate driver units are embedded in the liquid crystal panel and are interlaced at the left and right sides of the liquid crystal panel, and the trigger circuits and the timing controller are external circuits of the liquid crystal panel, and thereby optimizing the layout of the liquid crystal panel and saving production costs.

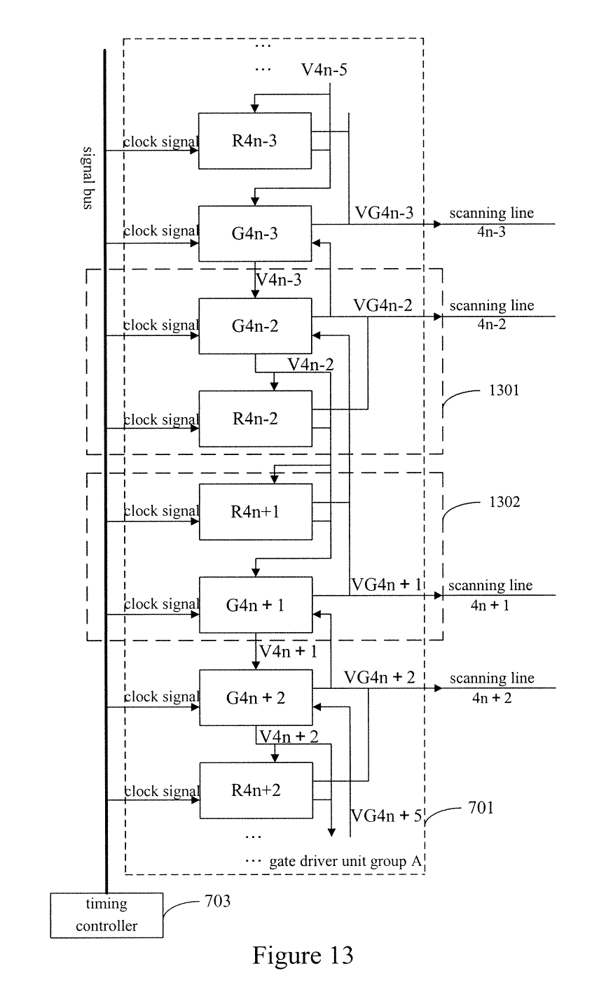

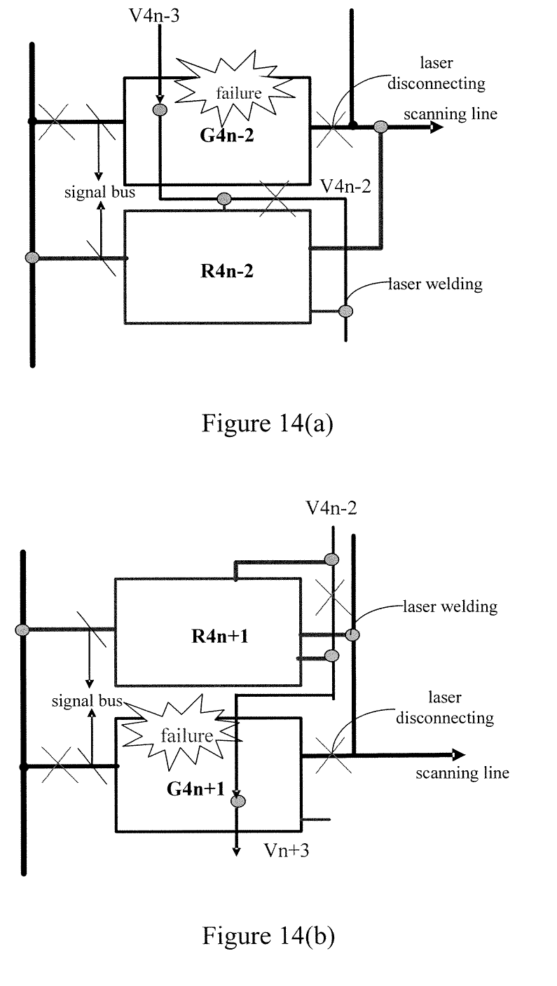

In the liquid crystal display apparatus according to the embodiments of the present invention, because the gate driver units are interlaced at the left and right sides of the liquid crystal panel, there is a blank area around each gate driver unit. Consequently, an embodiment of the present invention further provides a repair structure of a gate driver unit, i.e. the gate driver repair unit R is configured in the blank area corresponding to the gate driver unit G. The gate driver repair unit R is taken as a backup of the gate driver unit G when the gate driver unit G is in failure. FIG. 13 is a schematic diagram illustrating a part of repair structure of a driving apparatus of a liquid crystal panel adopting the double-dot inversion driving manner according to an embodiment of the present invention. As shown in FIG. 13, the gate driver unit G4n−2 is connected with the scanning line 4n−2 and the gate driver unit G4n+1 is connected with the scanning line 4n+1; the gate driver units G4n−1 and G4n respectively connected with the scanning lines 4n−1 and 4n between the scanning lines 4n−2 and 4n+1 are at the right side of the liquid crystal panel, and thus there is a blank area below the gate driver unit G4n−2 and a blank area upper the gate driver unit G4n+1. Consequently, as shown in dashed blocks 1301 and 1302 of FIG. 13 respectively, the repair unit R4n−2 of the gate driver unit G4n−2 is below the gate driver unit G4n−2, and the repair unit R4n+1 of the gate driver unit G4n+1 is upper the gate driver unit G4n+1. The repair structures shown by the dashed blocks 1301 and 1302 are illustrated respectively in FIGS. 14(a) and (b) in detail.

FIG. 14(a) is a schematic diagram illustrating a repair unit below a gate driver unit, and FIG. 14(b) is a schematic diagram illustrating a repair unit above a gate driver unit. With reference to FIG. 14(a) in view of FIG. 13, when the gate driver unit G4n−2 works normally, the gate driver unit G4n−2 is electrically connected with the scanning line 4n−2 and the signal bus; and the gate driver repair unit R4n−2 is not electrically connected with the signal bus but is just overlapped with each other, and an output end of a scanning pulse signal of the gate driver repair unit R4n−2 is also not electrically connected with the scanning line 4n−2 but is just overlapped with each other. When the gate driver unit G4n−2 is in failure, a connection from the gate driver unit G4n−2 to the signal bus and a connection from the gate driver unit G4n−2 to the scanning line 4n−2 are disconnected by laser, and the gate driver repair unit R4n−2 is connected by laser welding to both the scanning line 4n−2 and the signal bus which were ever connected with the gate driver unit G4n−2; a transmission path for the shift trigger signal V4n−2 of the gate driver unit G4n−2 to the gate driver unit G4n+1 is disconnected by the laser, and the gate driver repair unit R4n−2 is connected to the gate driver unit G4n−3 by the laser welding through a connection line between the gate driver unit G4n−2 and the gate driver unit G4n−3; thereby, the gate driver repair unit R4n−2 receives the shift trigger signal V4n−3 outputted by the gate driver unit G4n−3; a transmission path between the gate driver repair unit R4n−2 and the gate driver unit G4n+1 is connected by the laser welding. Thus, the gate driver repair unit R4n−2 may work normally in place of the gate driver unit G4n−2. The repair principle in FIG. 14(b) is the same as that in FIG. 14(a), and will not be described again.

FIGS. 13, 14(a) and 14(b) are schematic diagrams illustrating repair structures of the gate driver units at the two sides of the liquid crystal panel adopting the double-dot inversion driving manner. In the driving apparatus applied to the liquid crystal panel adopting the single-dot inversion driving manner, because there are blank areas below the gate driver units connected with the scanning lines in odd rows, the repair units may be configured below the gate driver units; similarly, because there are blank areas upper the gate driver units connected with the scanning lines in even rows, the repair units may be configured upper the gate driver units. The repair principle is the same as that illustrated in FIGS. 14(a) and 14(b), and will not be described again.

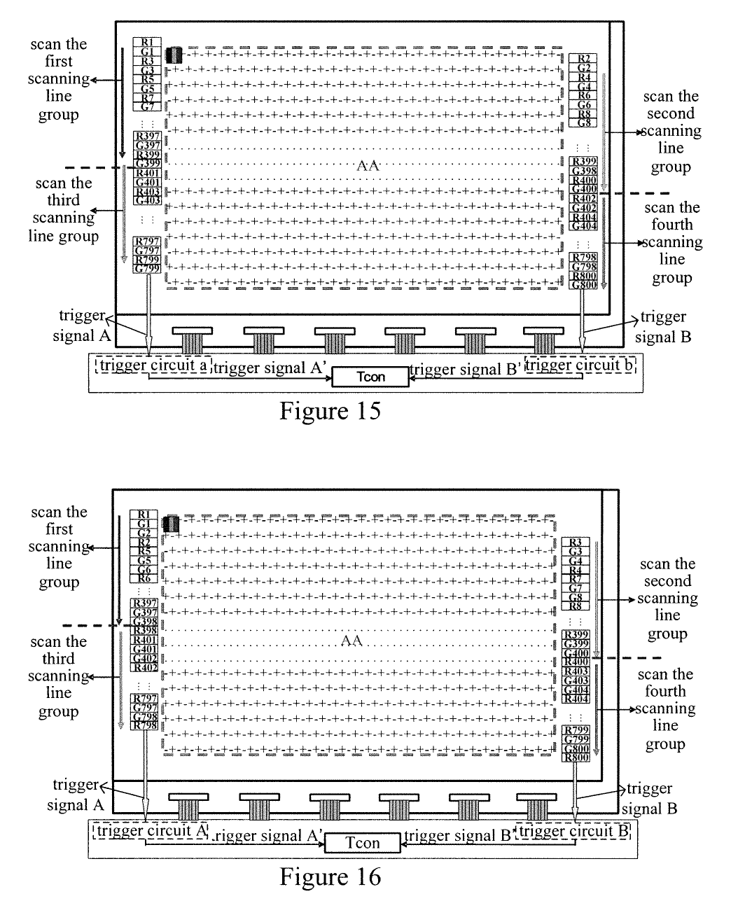

Because the gate driver units are used to drive the scanning lines of the liquid crystal panel and the gate driver units may be placed flexibly at the two sides of the liquid crystal panel, the scanning sequence of the scanning lines in one frame of time may be controlled flexibly through adjusting the placement and connection relation of the gate driver units at the two sides of the liquid crystal panel. For example, with respect to the liquid crystal panel adopting the single-dot inversion driving manner, the scanning lines may be scanned through a liquid crystal display apparatus shown in FIG. 15. In other words, the gate driver units are divided into four groups, each of the left and right sides of the liquid crystal panel has two groups, and the gate driver units in one group are electrically connected with one another while the gate driver units in different groups are not electrically connected with one another. The liquid crystal panel shown in FIG. 15 includes 800 scanning lines. In the first ¼ frame of time in one frame of time, the scanning lines 1, 3, 5, 7, . . . , 399 connected with one group of the gate driver units at the left side of the liquid crystal panel are scanned one by one from top to bottom; in the second ¼ frame of time in one frame of time, the scanning lines 2, 4, 6, 8, . . . , 400 connected with one group of the gate driver units at the right side of the liquid crystal panel are scanned one by one from top to bottom; in the third ¼ frame of time in one frame of time, the scanning lines 401, 403, . . . , 799 connected with the other group of the gate driver units at the left side of the liquid crystal panel are scanned one by one from top to bottom; and in the fourth ¼ frame of time in one frame of time, the scanning lines 402, 404, . . . , 800 connected with the other group of the gate driver units at the right side of the liquid crystal panel are scanned one by one from top to bottom. During the scanning process, the polarity of the data voltage on any data line is changed only after the scanning lines connected with one group of gate driver units are scanned. As can be seen, in one frame of time, the data voltage on each data line changes only three times, which are much less than the times in the conventional technology shown in FIG. 4, and thus power consumption can be saved effectively.

According to another embodiment of the present invention, in the liquid crystal display apparatus adopting the double-dot inversion driving manner, the gate driver units may also be divided into four groups and the four groups are interlaced at the left and right sides of the liquid crystal panel. As shown in FIG. 16, the liquid crystal panel adopting the double-dot inversion driving manner includes 800 scanning lines. In the first ¼ frame of time in one frame of time, the scanning lines 1, 2, 5, 6, . . . , 397 and 398 connected with one group of the gate driver units at the left side of the liquid crystal panel are scanned one by one from top to bottom; in the second ¼ frame of time in one frame of time, the scanning lines 3, 4, 7, 8, . . . , 399 and 400 connected with one group of the gate driver units at the right side of the liquid crystal panel are scanned one by one from top to bottom; in the third ¼ frame of time in one frame of time, the scanning lines 401, 402, . . . , 797 and 798 connected with the other group of the gate driver units at the left side of the liquid crystal panel are scanned one by one from top to bottom; and in the fourth ¼ frame of time in one frame of time, the scanning lines 403, 404, . . . , 799 and 800 connected with the other group of the gate driver units at the right side of the liquid crystal panel are scanned one by one from top to bottom. During the scanning process, the polarity of the data voltage on any data line is changed only after the scanning lines connected with one group of gate driver units are scanned. As can be seen, in one frame of time, the data voltage on each data line changes only three times, which are much less than the times in the conventional technology shown in FIG. 4, and thus power consumption can be saved effectively.

As can be seen from the above embodiments, the liquid crystal display apparatus according to the present invention includes M data lines arranged in columns, N scanning lines arranged in rows, and pixels determined by the intersection of the data lines and the scanning lines. M and N are integers greater than 1. The N scanning lines may be divided into 2K scanning line groups, wherein K is an integer greater than or equal to 1. The scanning lines of one scanning line group are connected with the pixels with the same polarity. The liquid crystal display apparatus further includes 2K driving components, each of which corresponds to one scanning line group and is configured to provide a plurality of levels of outputs; each level of outputs are connected with one scanning line in the corresponding scanning line group to activate the connected scanning line; and the 2K driving components are interlaced at the left and right sides of the scanning lines.

The liquid crystal display apparatus further includes a timing controller configured to provide clock signals for the 2K driving components and provide start signals for the 2K driving components in turn. Upon receiving a start signal, a driving component activates the scanning lines in the scanning line group corresponding to the driving component one by one according to the period of the clock signal. Each driving component includes N/2K gate driver units, and output ends of the N/2K gate driver units are respectively connected with the scanning lines in the scanning line group corresponding to the driving component; the first gate driver unit in the driving component receives a start signal provided by the timing controller, and outputs an activation signal to activate the scanning line connected with the first gate driver unit when the start signal provided by the timing controller arrives; the second gate driver unit to the final gate driver unit in the driving component respectively receive a shift trigger signal outputted simultaneously with the activation signal by a former gate driver unit, respectively output an activation signal to activate the scanning lines connected with the gate driver units in turn when the clock signal provided by the timing controller arrives, and further generate a scanning pulse signal for a former gate driver unit to notify the former gate driver unit to turn off the scanning line connected therewith.

The liquid crystal display apparatus further includes a trigger circuit configured to receive the shift trigger signal sent by the final gate driver unit in the driving component, and generate a trigger signal to the timing controller; the timing controller sends a start signal to the first gate driver unit in the next driving component upon receiving the trigger signal.

Certainly, the start signal may not be sent to the next driving component through the trigger circuit. Instead, it may be the timing controller that directly controls the switch between the driving components every ½K frame of time, i.e. because each driving component keeps in a driving state for ½K frame of time, the timing controller sends the start signal to the next driving component after ½K frame of time is past. Therefore, as can be seen from the embodiments of the present invention, by flexibly placing the gate driver units in the liquid crystal panel, i.e. by dividing the gate driver units into 2K groups and interlacing the 2K groups at the left and right sides of the liquid crystal panel, the data voltage is changed 2K−1 times in one frame of time, wherein K is an integer greater than or equal to 1. The manner of driving the scanning lines by the gate driving units not only can save power consumption but also can achieve better display quality.

The foregoing description is only the embodiments of the present invention and is not for use in limiting the protection scope thereof. All the modifications, equivalent replacements or improvements in the scope of the principle of the present invention should be included in the protection scope of the present invention.

What is claimed is:

1. A liquid crystal panel comprising:
M data lines arranged in columns;
N scanning lines arranged in rows;
pixels determined by intersection of the M data lines and the N scanning lines, M and N being integers greater than 1; and
N gate driver units, each of which is electrically connected with one scanning line to activate the scanning line, wherein
the N gate driver units are divided into 2K gate driver unit groups and the N scanning lines are divided into 2K scanning line groups, K being an integer greater than or equal to 1 and each scanning line group corresponding to one gate driver unit group, and
the 2K gate driver unit groups are interlaced at two sides of the liquid crystal panel, the gate driver units in each gate driver unit group of the 2K gate driver unit groups are cascaded with one another and the gate driver units in different gate driver unit groups of the 2K gate driver unit groups are not connected with one another.

2. The liquid crystal panel of claim 1, wherein each scanning line is electrically connected with all the pixels in one row and each data line is electrically connected with all the pixels in one column.

3. The liquid crystal panel of claim 2, wherein the K is 1 and the N scanning lines are divided into two scanning line groups;
one of the two scanning line groups comprises scanning lines in odd rows of the N scanning lines, and the other of the two scanning line groups comprises scanning lines in even rows of the N scanning lines.

4. The liquid crystal panel of claim 3, further comprising N gate driver repair units, wherein each gate driver repair unit corresponds to one gate driver unit and is configured to, if the gate driver unit corresponding to the gate driver repair unit is in failure, connect to a scanning line connected with the gate driver unit in failure in place of the gate driver unit in failure.

5. The liquid crystal panel of claim 2, wherein the K is 1 and the N scanning lines are divided into two scanning line groups and N/2 scanning line subgroups,
wherein each scanning line subgroup comprises two scanning lines adjacent to each other,
wherein one of the two scanning line groups comprises scanning lines in odd subgroups of the N/2 scanning line subgroups, and
wherein the other of the two scanning line groups comprises scanning lines in even subgroups of the N/2 scanning line subgroups.

6. The liquid crystal panel of claim 5, further comprising N gate driver repair units, wherein each gate driver repair unit corresponds to one gate driver unit, and is configured to, if the gate driver unit corresponding to the gate driver repair unit is in failure, connect to a scanning line connected with the gate driver unit in failure in place of the gate driver unit in failure.

7. A liquid crystal display apparatus comprising:
M data lines arranged in columns;
N scanning lines arranged in rows;
pixels determined by intersection of the M data lines and the N scanning lines, M and N being integers greater than 1; and
2K driving components, wherein
the N scanning lines are divided into 2K scanning line groups, K being an integer greater than or equal to 1, the scanning lines in each scanning line group being connected with pixels having the same polarity, and
each of the 2K driving components corresponds to one scanning line group and is configured to provide a plurality of levels of outputs, each level of outputs being connected with one scanning line in the scanning line group to activate the scanning line.

8. The liquid crystal display apparatus of claim 7, further comprising;
a timing controller, configured to provide clock signals for the 2K driving components and provide start signals for the 2K driving components in turn,
wherein each driving component activates the scanning lines in the scanning line group corresponding to the driving component one by one according to a period of a clock signal upon receiving a start signal.

9. The liquid crystal display apparatus of claim 8, wherein each driving component comprises N/2K gate driver units, output ends of the N/2K gate driver units being respectively connected to the scanning lines in the scanning line group corresponding to the driving component,
wherein the first gate driver unit in each driving component is configured to the start signal provided by the timing controller, and to output an activation signal to activate the scanning line connected with the first gate driver unit when the clock signal provided by the timing controller arrives, and
wherein the second gate driver unit to the final gate driver unit in the driving component is configured to receive a shift trigger signal outputted simultaneously with the activation signal by a former gate driver unit in turn, and when the clock signal provided by the timing controller arrives, to output an activation signal in turn to activate scanning lines respectively connected with the second gate driver unit to the final gate driver unit, to generate and to return a scanning pulse signal to the former gate driver unit to notify the former gate driver unit to turn off the scanning line connected with the former gate driver unit.

10. The liquid crystal display apparatus of claim 9, further comprising a trigger circuit, configured to receive the shift trigger signal outputted by the final gate driver unit in the driving component, and generate a trigger signal to the timing controller, wherein the timing controller is configured to send a start signal to the first gate driver unit in the next driving component upon receiving the trigger signal.

11. The liquid crystal display apparatus of claim 9, wherein each driving component keeps in a driving state for ½K frame of time in one frame of time, and switching is from one driving component to the next driving component is performed every ½K frame of time.

12. The liquid crystal display apparatus of claim 9, wherein the timing controller sends the start signal to the next driving component when the ½K frame of time is past.

13. The liquid crystal display apparatus of claim 9, wherein the 2K driving components are interlaced at the left and right sides of the N scanning lines.

14. The liquid crystal display apparatus of claim 7 wherein the K is equal to 1, the N scanning lines are divided into two scanning line groups,
wherein one of the two scanning line groups comprises scanning lines in odd rows among the N scanning lines, and
wherein the other of the two scanning line groups comprises scanning lines in even rows among the N scanning lines.

15. The liquid crystal display apparatus of claim 7, wherein the K is equal to 1, the N scanning lines are divided into two scanning line groups and N/2 scanning line subgroups,
wherein each scanning line subgroup comprises two scanning lines adjacent to each other,
wherein one of the two scanning line groups comprises scanning lines in odd subgroups among the N/2 scanning line subgroups, and
wherein the other of the two scanning line groups comprises scanning lines in even subgroups among the N/2 scanning line subgroups.

16. The liquid crystal display apparatus of claim 13, further comprising N gate driver repair units, wherein each gate driver repair unit corresponds to one gate driver unit, and is configured to, if the gate driver unit corresponding to the gate driver repair unit is in failure, connect to a scanning line connected with the gate driver unit in failure in place of the gate driver unit in failure.

17. A driving apparatus of a liquid crystal panel, applied to M data lines arranged in columns, N scanning lines arranged in rows, and pixels determined by intersection of the M data lines and the N scanning lines, M and N being integers greater than 1 wherein the N scanning lines are divided into 2K scanning line groups, K being an integer greater than or equal to 1, and the scanning lines in each scanning line group are connected with pixels having the same polarity, the driving apparatus comprises:
2K driving components, each of which corresponds to one scanning line group and is configured to provide a plurality of levels of outputs, each level of output being connected with one scanning line in the scanning line group to activate the scanning line.

18. The driving apparatus of claim 17, further comprising:
a timing controller, configured to provide clock signals for the 2K driving components and provide start signals for the 2K driving components in turn, wherein each driving component activates the scanning lines in the scanning line group corresponding to the driving component one by one according to a period of a clock signal upon receiving a start signal.

19. The driving apparatus of claim 18, wherein each driving component comprises N/2K gate driver units, output ends of the N/2K gate driver units being respectively connected to the scanning lines in the scanning line group corresponding to the driving component,
wherein the first gate driver unit in each driving component is configured to receive the start signal provided by the timing controller, and to output an activation signal to activate the scanning line connected with the first gate driver unit when the clock signal provided by the timing controller arrives, and
wherein the second gate driver unit to the final gate driver unit in the driving component is configured to receive a shift trigger signal outputted simultaneously with the activation signal by a former gate driver unit in turn, and when the clock signal provided by the timing controller arrives, to output an activation signal in turn to activate scanning lines respectively connected with the second gate driver unit to the final gate driver unit, to generate and to return a scanning pulse signal to the former gate driver unit to notify the former gate driver unit to turn off the scanning line connected with the former gate driver unit.

20. The driving apparatus of claim 19, further comprising:
a trigger circuit, configured to receive the shift trigger signal outputted by the final gate driver unit in the driving component, and generate a trigger signal to the timing controller,
wherein the timing controller is configured to send a start signal to the first gate driver unit in the next driving component upon receiving the trigger signal.

21. The driving apparatus of claim 19, wherein each driving component keeps in a driving state for ½K frame of time in one frame of time, and switching from one driving component to the next driving component is performed every ½K frame of time.

22. The driving apparatus of claim 21, wherein the timing controller sends the start signal to the next driving component when the ½K frame of time is past.

23. The driving apparatus of claim 19, wherein the 2K driving components are interlaced at the left and right sides of the N scanning lines.

24. The driving apparatus of claim 17, wherein the K is equal to 1, the N scanning lines are divided into two scanning line groups,
wherein one of the two scanning line groups comprises scanning lines in odd rows among the N scanning lines, and
wherein the other of the two scanning line groups comprises scanning lines in even rows among the N scanning lines.

25. The driving apparatus of claim 17, wherein the K is equal to 1, the N scanning lines are divided into two scanning line groups and N/2 scanning line subgroups,
wherein each scanning line subgroup comprises two scanning lines adjacent to each other,
wherein one of the two scanning line groups comprises scanning lines in odd subgroups among the N/2 scanning line subgroups, and
wherein the other of the two scanning line groups comprises scanning lines in even subgroups among the N/2 scanning line subgroups.

26. The driving apparatus of claim 23, further comprising N gate driver repair units, wherein each gate driver repair unit corresponds to one gate driver unit, and is configured to, if the gate driver unit corresponding to the gate driver repair unit is in failure, connect to a scanning line connected with the gate driver unit in failure in place of the gate driver unit in failure.
